(19) United States
(12) Patent Application Publication
(10) Pub. No.: US 2026/0070078 A1
(43) Pub. Date: Mar. 12, 2026

(54) COATING DEVICE AND LIQUID DISCHARGE APPARATUS

(71) Applicant: Eri UCHIDA, Kanagawa (JP)

(72) Inventor: Eri UCHIDA, Kanagawa (JP)

(73) Assignee: Ricoh Company, Ltd., Tokyo (JP)

(21) Appl. No.: 19/296,396

(22) Filed: Aug. 11, 2025

(30) Foreign Application Priority Data
Sep. 6, 2024 (JP) 2024-153725

(51) Int. Cl. B05C 1/08; B41J 11/00

(52) U.S. Cl. CPC B05C 1/0873; B05C 1/0821; B41J 11/0015; B41J 11/0095

(57) ABSTRACT

A coating device includes a conveyor, a driver, circuitry, and a digital-to-analog converter. The conveyor includes a coating roller to coat a medium with a liquid while conveying the medium in a conveyance direction. The driver rotates the coating roller at a rotation speed. The circuitry outputs a speed command value as a digital value. The digital-to-analog converter converts the speed command value as the digital value into an analog voltage value. Further, the circuitry calculates a correction amount to correct the speed command value, reflects the correction amount in the speed command value when the medium is not passing through the coating roller, and applies the speed command value, as the analog voltage value corrected by the correction amount, to the driver to rotate the coating roller at the rotation speed to convey the medium.

### CROSS-REFERENCE TO RELATED APPLICATION

This patent application is based on and claims priority pursuant to 35 U.S.C. §119(a) to Japanese Patent Application No. 2024-153725, filed on Sep. 6, 2024, in the Japan Patent Office, the entire disclosure of which is hereby incorporated by reference herein.

### BACKGROUND

### Technical Field

The present disclosure relates to a coating device and a liquid discharge apparatus.

### Related Art

A liquid discharge apparatus discharges a liquid such as ink onto a medium as a recording medium to form (print) an image on the medium. Before an image forming process, a treatment agent for pre-coating is applied to the medium to enhance image quality. Specifically, before the image forming process, a coating roller bearing the treatment agent and a conveyance roller opposed to the coating roller via the medium support the medium therebetween. The coating roller coats the medium with the treatment agent when the medium passes between the coating roller and the conveyance roller. In such a liquid discharge apparatus, typically, a digital-and-analog (DA) board including a digital-to-analog (D/A) converter converts a digital speed command value into an analog voltage value, and a motor speed is controlled by the analog voltage value.

### SUMMARY

The present disclosure described herein provides an improved coating device including a conveyor, a driver, circuitry, and a digital-to-analog converter. The conveyor includes a coating roller to coat a medium with a liquid while conveying the medium in a conveyance direction. The driver rotates the coating roller at a rotation speed. The circuitry outputs a speed command value as a digital value. The digital-to-analog converter converts the speed command value as the digital value into an analog voltage value. Further, the circuitry calculates a correction amount to correct the speed command value, reflects the correction amount in the speed command value when the medium is not passing through the coating roller, and applies the speed command value, as the analog voltage value corrected by the correction amount, to the driver to rotate the coating roller at the rotation speed to convey the medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIG. 2 is another diagram illustrating an overall configuration of an image forming apparatus;

FIG. 3 is a diagram illustrating a configuration of a pre-coating device of an image forming apparatus;

FIG. 4 is a diagram illustrating a configuration of a coating unit of a pre-coating device of an image forming apparatus;

FIG. 5 is a diagram illustrating a configuration of a coating roller of a coating unit of a pre-coating device of an image forming apparatus;

FIG. 6 is another diagram illustrating a configuration of a coating roller of a coating unit of a pre-coating device of an image forming apparatus;

FIG. 7 is a block diagram illustrating a hardware configuration of an image forming apparatus;

FIG. 8 is a diagram illustrating a relationship between a speed of a coating roller and a coating amount on a medium;

FIG. 9 is a block diagram illustrating a functional configuration of an image forming apparatus;

FIG. 10 is a flowchart of a drive control process of a coating roller according to a first embodiment of the present disclosure;

FIG. 11 is a flowchart of a drive control process of a coating roller according to a second embodiment of the present disclosure;

FIG. 12 is a flowchart of a drive control process of a coating roller according to a third embodiment of the present disclosure; and

FIG. 13 is a lookup table of a correction amount according to a type of medium.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A conveyance device and an image forming apparatus according to an embodiment of the present disclosure are described in detail below with reference to the accompanying drawings.

### First Embodiment

The conveyance device and the image forming apparatus are described in detail below with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### Overall Configuration of Image Forming Apparatus

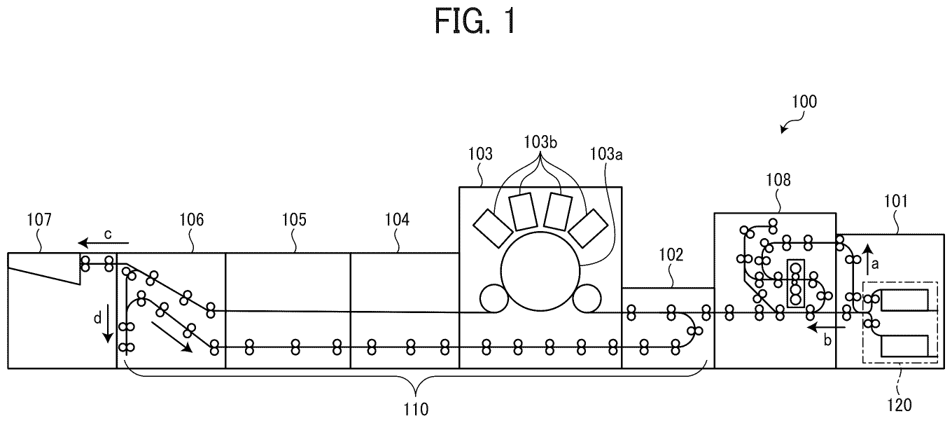

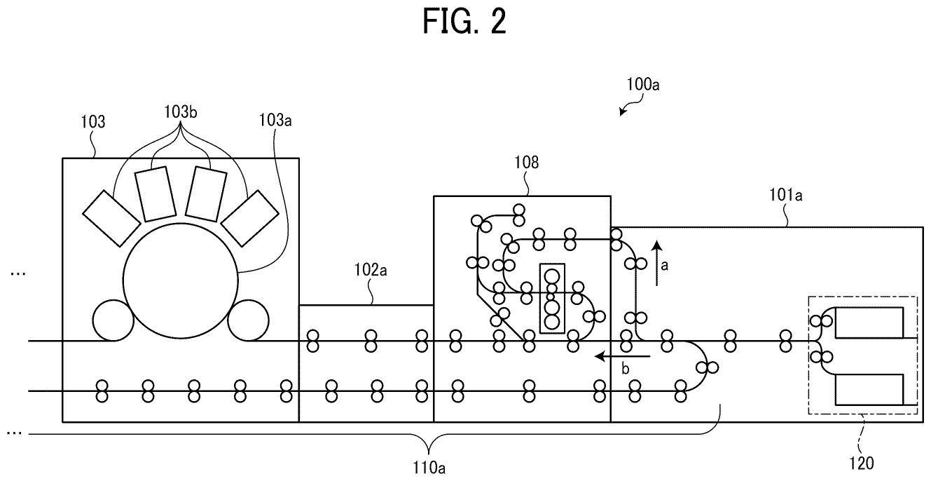

FIG. 1 is a diagram illustrating an overall configuration of an image forming apparatus. FIG. 2 is another diagram illustrating an overall configuration of an image forming apparatus. The overall configuration of an image forming apparatus 100 (or 100a), which is an example of a liquid discharge apparatus, will be described below with reference to FIGS. 1 and 2.

The image forming apparatus 100 illustrated in FIG. 1 is a commercial printer that discharges ink (liquid) onto a medium (recording medium) such as a sheet by an inkjet method to form an image on the recording medium. The image forming apparatus 100 includes a sheet feeding device 101, a pre-coating device 108 (coating device), a registration device 102, an image forming device 103, a drying device 104, a cooling device 105, a reverse device 106, and a sheet ejection device 107.

The recording medium may be another medium such as plain paper, gloss paper, special paper, a non-permeable base material, ceramics, glass, or metal. The recording medium may be a fabric, a textile, or leather used for clothing such as a T-shirt, or a construction material such as wallpaper, flooring, or a tile.

The sheet feeding device 101 is a unit that separates and conveys media (recording media) one by one from a sheet feeding tray 120. The medium separated from the other media and conveyed from the sheet feeding tray 120 is fed to the pre-coating device 108. The sheet feeding device 101 can switch a path of the medium between when the pre-coating device 108 pre-coats the medium with a treatment agent and when the pre-coating device 108 does not pre-coat the medium with the treatment agent. When the pre-coating of the treatment agent is not performed, the sheet feeding device 101 conveys the medium along a path b illustrated in FIG. 1. When the pre-coating of the treatment agent is performed, the sheet feeding device 101 conveys the medium along a path a illustrated in FIG. 1. In the following description, the pre-coating device 108 pre-coats the medium with the treatment agent, and the sheet feeding device 101 conveys the medium along the path a.

The pre-coating device 108 is a unit that applies the treatment agent for pre-coating to one face or both faces of the medium conveyed and fed from the sheet feeding device 101 along the path a. The pre-coating device 108 conveys the medium pre-coated with the treatment agent by the pre-coating device 108 to the registration device 102. The treatment agent for pre-coating is applied as a pretreatment for an image forming process in the image forming device 103 to facilitate the agglomeration of ink landing on the medium.

The registration device 102 is a unit that appropriately corrects the posture of the medium conveyed from the pre-coating device 108. The registration device 102 conveys the medium whose posture has been corrected by the registration device 102 to the image forming device 103.

The image forming device 103 is a unit that discharges ink (liquid) onto the medium conveyed from the registration device 102 to form (print) an image on the medium. As illustrated in FIG. 1, the image forming device 103 includes an image forming conveyance drum 103a and inkjet heads 103b (discharge heads). The image forming conveyance drum 103a is a conveyance drum that rotates and conveys the medium conveyed from the registration device 102 toward the inkjet heads 103b. Each of the inkjet heads 103b is a discharge head that discharges ink onto the medium conveyed by the image forming conveyance drum 103a to form (print) an image. The image forming device 103 conveys the medium on which the image is formed (printed) by the image forming device 103 to the drying device 104.

The drying device 104 is a unit that dries the medium conveyed from the image forming device 103. In the image forming apparatus 100 illustrated in FIG. 1, one drying device 104 is installed, but the drying device 104 is not limited to one, and multiple drying devices may be installed in the image forming apparatus 100 according to drying conditions. The drying device 104 conveys the medium dried by the drying device 104 to the cooling device 105.

The cooling device 105 is a unit that cools the dried medium conveyed from the drying device 104. The cooling device 105 conveys the medium cooled by the cooling device 105 to the reverse device 106.

The reverse device 106 is a unit that reverses the conveyance direction of the medium in switchback manner in a path d to reverse the medium and conveys the medium to a duplex conveyance path 110 as illustrated in FIG. 1, when images are printed on both faces of the medium conveyed from the cooling device 105. The medium conveyed to the duplex conveyance path 110 is fed to the registration device 102 again. The image forming device 103 forms (prints) an image on a second face, which is a back face of a first face on which an image has already been formed (printed) by the image forming device 103. When an image is formed (printed) on only one face of the medium conveyed from the cooling device 105, the reverse device 106 conveys the medium to the sheet ejection device 107 through a path c as illustrated in FIG. 1.

The sheet ejection device 107 is a unit that ejects the medium conveyed from the reverse device 106 to a sheet ejection tray.

In the image forming apparatus 100 illustrated in FIG. 1, when the medium is reversed by the reverse device 106 to form (print) images on both faces of the medium, the medium is fed to the registration device 102 again, i.e., the medium is re-fed to the downstream side of the pre-coating device 108. Alternatively, as in the image forming apparatus 100a illustrated in FIG. 2, the medium may be re-fed to the upstream side of the pre-coating device 108.

In the image forming apparatus 100a illustrated in FIG. 2, the medium is fed to the pre-coating device 108 again by a sheet feeding device 101a disposed upstream of the pre-coating device 108. In FIG. 2, the configuration of the units downstream of the image forming device 103 is the same as that in FIG. 1, and thus the illustration thereof is omitted.

The medium separated and conveyed from the sheet feeding tray 120 in the sheet feeding device 101a is pre-coated with the treatment agent by the pre-coating device 108, and then the posture of the medium is corrected by a registration device 102a, and the medium is conveyed to the image forming device 103. In the case of the duplex printing, similarly to FIG. 1, the medium reversed by the reverse device 106 passes through a duplex conveyance path 110a, is fed to the pre-coating device 108 again by the sheet feeding device 101a disposed upstream of the pre-coating device 108. Then, the pre-coating device 108 pre-coats the second face, which is the back face of the first face on which the treatment agent has already been applied and an image has been printed, with the treatment agent, and the image forming device 103 forms (prints) an image on the second face.

### Configuration of Pre-Coating Device

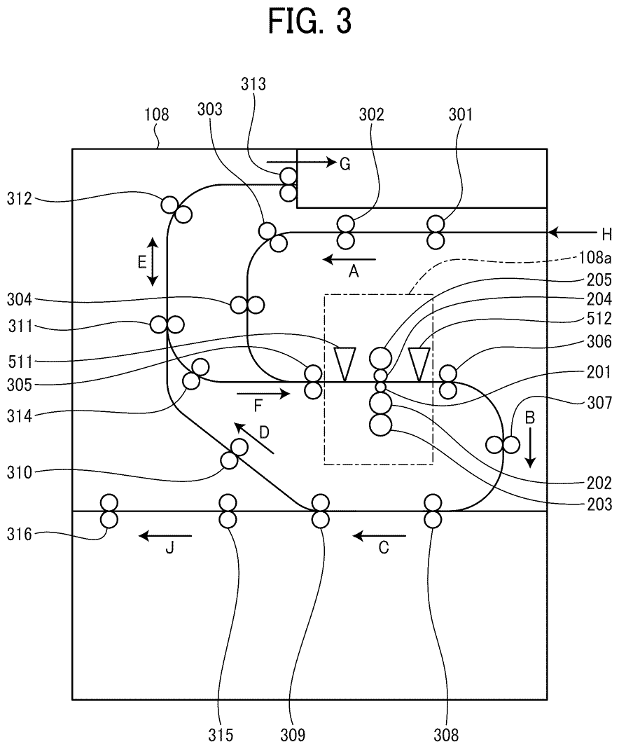

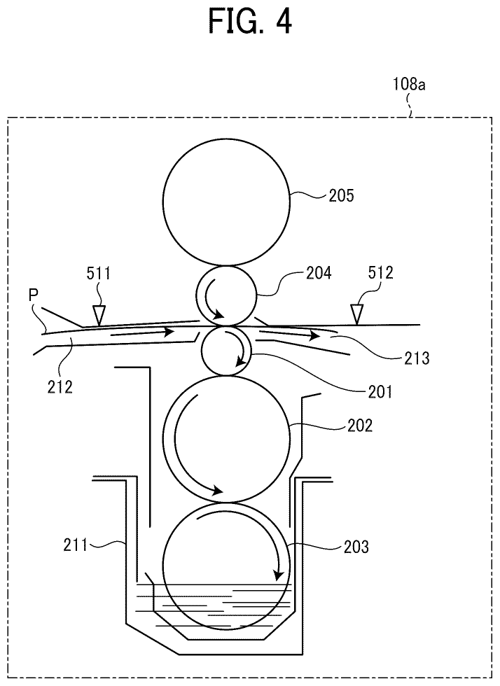

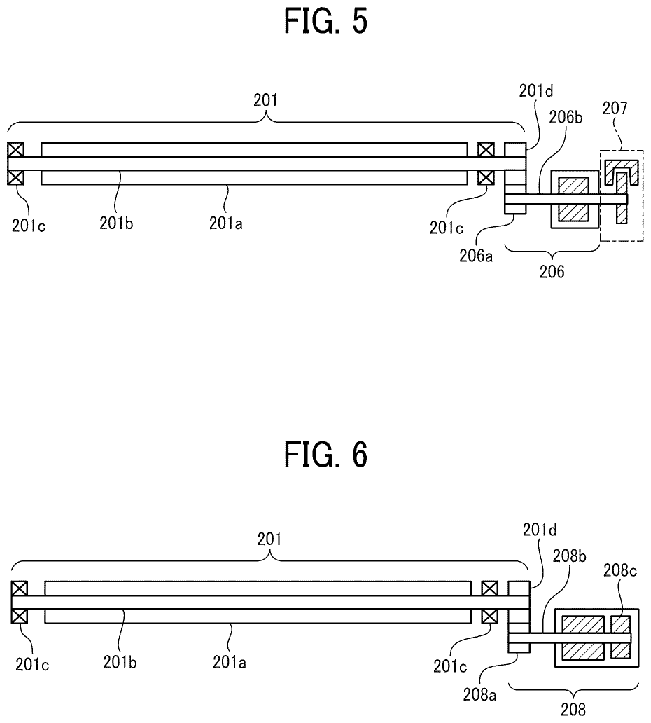

FIG. 3 is a diagram illustrating a configuration of a pre-coating device of an image forming apparatus. FIG. 4 is a diagram illustrating a configuration of a coating unit of the pre-coating device of the image forming apparatus. FIG. 5 is a diagram illustrating a configuration of a coating roller of the coating unit of the pre-coating device of the image forming apparatus. FIG. 6 is another diagram illustrating a configuration of a coating roller of the coating unit of the pre-coating device of the image forming apparatus. The configuration of the pre-coating device 108 of the image forming apparatus 100 will be described below with reference to FIGS. 3 to 6.

As illustrated in FIG. 3, the pre-coating device 108 includes a coating unit 108a, inlet roller pairs 301 to 305, outlet roller pairs 306 to 309, purge roller pairs 310 to 313, a re-inlet roller pair 314, and outlet roller pairs 315 and 316. The coating unit 108a is a coating device that applies the treatment agent for pre-coating to the medium. The medium enters the pre-coating device 108 from an inlet section H and is conveyed by the inlet roller pairs 301 to 305. The configuration of the coating unit 108a will be described in detail later.

The inlet roller pairs 301 to 305 are conveyance rollers that convey the medium entering the pre-coating device 108 from the inlet section H to the coating unit 108a along a conveyance path A. The outlet roller pairs 306 to 309 are rollers that convey the medium to which the treatment agent is applied by the coating unit 108a along a conveyance path B and a conveyance path C illustrated in FIG. 3.

When the treatment agent is applied to both faces of the medium, the coating unit 108a applies the treatment agent to the first face of the medium. After that, the outlet roller pairs 306 to 309 convey the medium, and then the purge roller pair 310 conveys the medium, which is guided into a conveyance path D by a separator, along the conveyance path D.

On the other hand, when the treatment agent is applied to only one face of the medium, the coating unit 108a applies the treatment agent to the first face of the medium. After that, the outlet roller pairs 306 to 309 convey the medium, and then the outlet roller pairs 315 and 316 convey the medium, which is guided into a conveyance path J by the separator, to the registration device 102 along the conveyance path J.

The purge roller pair 310 is conveyance rollers that convey the medium to the purge roller pairs 311 to 313 to reverse the conveyance direction of the medium having the first face coated with the treatment agent in switchback manner. The purge roller pairs 311 to 313 are conveyance rollers that convey the medium, which is conveyed by the purge roller pair 310, along a conveyance path E and a conveyance path G illustrated in FIG. 3 to reverse the conveyance direction of the medium in switchback manner. After the conveyance direction of the medium is reversed in switchback manner by the purge roller pairs 311 to 313, the medium is conveyed again to the coating unit 108a along a conveyance path F by the re-inlet roller pair 314, and the treatment agent is applied to the second face of the medium. The conveyance path E and the conveyance path G by the purge roller pairs 311 to 313 can be used as a purge path to purge the medium from the pre-coating device 108.

The re-inlet roller pair 314 is conveyance rollers that convey the medium, which is reversed in switchback manner by the purge roller pairs 311 to 313, to the coating unit 108a along the conveyance path F. The outlet roller pairs 315 and 316 are conveyance rollers that convey the medium conveyed along the conveyance path B and the conveyance path C by the outlet roller pairs 307 to 309 to the registration device 102 along the conveyance path J.

Although the medium reversed by the reverse device 106 is fed to the upstream side of the pre-coating device 108 again as in the image forming apparatus 100a illustrated in FIG. 2, the treatment agent can be applied to both sides of the medium in the pre-coating device 108 before the medium is conveyed to the registration device 102a. Alternatively, the treatment agent may be applied to the first face of the medium in the pre-coating device 108, the medium may be conveyed to the registration device 102a, and then an image may be formed (printed) on the first face of the medium. After that, the medium may be conveyed through the duplex conveyance path 110a to apply the treatment liquid to the second face of the medium by the pre-coating device 108. In this case, it is not necessary to reverse the conveyance direction of the medium in switchback manner in the pre-coating device 108, and thus the pre-coating device 108 may not include the purge roller pairs 310 to 313 and the re-inlet roller pair 314.

With the above configuration, as illustrated in FIG. 3, the medium ejected from the sheet feeding device 101 is conveyed from the inlet section H to the coating unit 108a via the conveyance path A. The medium to which the treatment agent is applied by the coating unit 108a is fed to the conveyance path C via the conveyance path B. When the treatment agent is applied to only one face of the medium, the medium to which the treatment agent is applied by the coating unit 108a is fed to the registration device 102 via the horizontal conveyance path J.

A specific configuration of the coating unit 108a of the pre-coating device 108 will be described below with reference to FIGS. 4 to 6. As illustrated in FIG. 4, the coating unit 108a includes a coating roller 201, a fixed roller 202, a squeeze roller 203, a pressure roller 204, a pressing roller 205, a treatment agent pan 211, an inlet sensor 511, and an outlet sensor 512. As illustrated in FIG. 4, the squeeze roller 203, the fixed roller 202, the coating roller 201, the pressure roller 204, and the pressing roller 205 are arranged in this order from the bottom.

The coating roller 201 applies the treatment agent for pre-coating to the lower surface of a medium P while rotating. The medium P is conveyed from an upstream conveyance path 212. The treatment agent, which is liquid, is supplied from the surface of the fixed roller 202 to the coating roller 201. The coating roller 201 is a conveyor that sandwiches the medium P, to which the treatment agent for pre-coating is applied, with the pressure roller 204 and conveys the medium P toward a downstream conveyance path 213. The configuration of the coating roller 201 will be described in detail later.

The fixed roller 202 supplies the treatment agent supplied from the squeeze roller 203 to the coating roller 201 while rotating. The squeeze roller 203 is impregnated with the treatment agent filled in the treatment agent pan 211, and supplies the treatment agent to the fixed roller 202 while rotating. The squeeze roller 203 also has a function of stirring the treatment agent filled in the treatment agent pan 211.

The pressure roller 204 is pressed against the coating roller 201 from above. When the medium P is conveyed from the upstream conveyance path 212 to the coating roller 201, the pressure roller 204 presses the medium P against the coating roller 201. The pressing roller 205 applies a downward load to the pressure roller 204 and the coating roller 201 and rotates following the rotation of the pressure roller 204.

The medium P conveyed from the upstream conveyance path 212 is coated with the treatment agent by the coating roller 201, and then conveyed toward the outlet roller pair 306 illustrated in FIG. 3 via the downstream conveyance path 213. The coating roller 201, the fixed roller 202, the squeeze roller 203, and the pressure roller 204 are rotated by a motor 206, which is the same driving source described later. The coating roller 201 and the squeeze roller 203 rotate clockwise in FIG. 4, and the fixed roller 202 and the pressure roller 204 rotate counterclockwise in FIG. 4. The treatment agent pan 211 stores the treatment agent, which is liquid.

The inlet sensor 511 detects the medium P conveyed through the upstream conveyance path 212 (i.e., the medium P passing by the inlet sensor 511 or entering the coating roller 201). The outlet sensor 512 detects the medium P coated with the treatment agent by the coating roller 201 and conveyed through the downstream conveyance path 213 (i.e., the medium P passing by the outlet sensor 512 or exiting the coating roller 201).

With the above configuration, as illustrated in FIG. 4, after the medium P is conveyed through the upstream conveyance path 212 and passes by the inlet sensor 511, the treatment agent is applied to the surface of the medium P between the coating roller 201 and the pressure roller 204, and the medium P is conveyed through the downstream conveyance path 213 and passes by the outlet sensor 512.

A specific configuration of the coating roller 201 will be described below with reference to FIG. 5. As illustrated in FIG. 5, the coating roller 201 includes a roller body 201a, a roller core 201b, bearings 201c, and a reduction gear 201d. The roller body 201a is a roller portion as a body of the coating roller 201. The roller core 201b is a metal rod penetrating the roller body 201a in the axial direction. The bearings 201c support both ends of the roller core 201b. The reduction gear 201d is fixed to one end of the roller core 201b.

The coating unit 108a further includes a motor 206 (an example of a driver) and an encoder 207 illustrated in FIG. 5. The motor 206 is preferably an alternating current (AC) servo motor having high power and high responsiveness. The motor 206 includes a motor shaft 206b that is rotated by the rotation drive of the motor 206 and a motor gear 206a fixed to an end of the motor shaft 206b.

As illustrated in FIG. 5, the reduction gear 201d and the motor gear 206a mesh with each other. Accordingly, when the motor shaft 206b is rotated by the rotation drive of the motor 206, the coating roller 201 is rotated via the motor gear 206a and the reduction gear 201d. Further, the coating roller 201 has a degree of freedom in the vertical direction and, thus, is displaceable in the vertical direction by being pressed by the pressure roller 204.

The encoder 207 is attached to the motor shaft 206b of the motor 206. The encoder 207 is a sensor that detects the number of revolutions of the motor 206. The encoder 207 transmits the detected number of revolutions of the motor 206 to a coating unit roller driver 411 described later. The coating unit 108a may include a motor 208 (an example of a driver) provided with a built-in encoder illustrated in FIG. 6 instead of the motor 206 to rotate the coating roller 201.

The motor 208 illustrated in FIG. 6 includes a motor shaft 208b that is rotated by the rotation drive of the motor 208, a motor gear 208a fixed to an end of the motor shaft 208b, and an encoder 208c built into a body of the motor 208. In this case, the reduction gear 201d and the motor gear 208a mesh with each other. Accordingly, when the motor shaft 208b is rotated by the rotation drive of the motor 208, the coating roller 201 is rotated via the motor gear 208a and the reduction gear 201d. In the following description, the coating unit 108a includes the motor 206 illustrated in FIG. 5.

### Hardware Configuration of Image Forming Apparatus

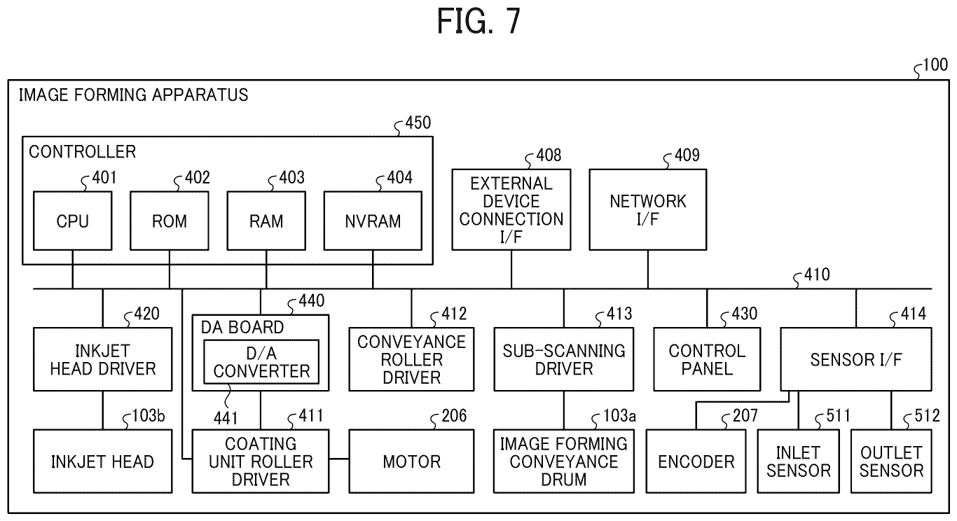

FIG. 7 is a block diagram illustrating a hardware configuration of an image forming apparatus. With reference to FIG. 7, a description will be given below of a portion related to the pre-coating device 108 in the hardware configuration of the image forming apparatus 100.

As illustrated in FIG. 7, the image forming apparatus 100 includes a central processing unit (CPU) 401, a read-only memory (ROM) 402, a random-access memory (RAM) 403, a nonvolatile random-access memory (NVRAM) 404, an external device connection interface (I/F) 408, a network I/F 409, the coating unit roller driver 411 (drive circuit), a conveyance roller driver 412, a sub-scanning driver 413, a sensor I/F 414, an inkjet head driver 420, an control panel 430, and a digital-and-analog (DA) board 440 including a digital-to-analog (D/A) converter 441.

The CPU 401 is a processor that controls the entire operation of the image forming apparatus 100. The ROM 402 is a nonvolatile storage device that stores a program such as an initial program loader (IPL). The RAM 403 is a volatile storage device used as a work area for the CPU 401. The NVRAM 404 is a nonvolatile storage device that stores various kinds of data such as programs and retains the various kinds of data even while the image forming apparatus 100 is powered off. The CPU 401, the ROM 402, the RAM 403, and the NVRAM 404 construct a controller 450 as circuitry.

The external device connection I/F 408 is connected to an external device such as a personal computer (PC) by, for example, a universal serial bus (USB) cable to transmit and receive control signals and data of images to be printed to and from the external device. The network I/F 409 is an interface in conformity with a transmission control protocol (TCP)/Internet protocol (IP) for data communication via, for example, the Internet or a local area network (LAN). For example, the network I/F 409 may be a wired communication interface in conformity with Ethernet (registered trademark) or may be a wireless communication interface in conformity with WiFi (registered trademark).

The controller 450 outputs a speed command value for the motor 206. The speed command value for the motor 206 from the controller 450 is output as a digital value of 12 bits (i.e., a digital signal). The D/A converter 441 of the DA board 440 converts the speed command value from the controller 450 into an analog voltage value proportional to the speed command value, and outputs the analog voltage value to the coating unit roller driver 411. The analog voltage value ranges from −10 V to +10 V

The coating unit roller driver 411 is a drive circuit that drives the motor 206 to rotate the coating roller 201 of the pre-coating device 108. The coating unit roller driver 411 outputs a drive current to the motor 206, which rotates the coating roller 201, to rotate the motor 206. The coating unit roller driver 411 controls the speed of the motor 206 using the analog voltage value converted by the D/A converter 441 of the DA board 440 as a speed command value. In other words, the coating unit roller driver 411, which may be included the controller 450, as a drive circuit applies the analog voltage value to the motor 206 as a driver.

The conveyance roller driver 412 is a drive circuit that independently drives the inlet roller pairs 301 to 305, the outlet roller pairs 306 to 309, the purge roller pairs 310 to 313, the re-inlet roller pair 314, and the outlet roller pairs 315 and 316 of the pre-coating device 108 to rotate. The sub-scanning driver 413 is a drive circuit that rotationally drives the image forming conveyance drum 103a of the image forming device 103 to convey the medium in the conveyance direction, i.e., the sub-scanning direction.

The sensor I/F 414 receives signals detected by sensors such as the inlet sensor 511, the outlet sensor 512, and the encoder 207. The inkjet head driver 420 is a drive circuit that controls a discharge operation of the inkjet head 103b. The control panel 430 is a device that displays, for example, setting data of the image forming apparatus 100 and various screens. The control panel 430 includes a touch panel that receives an operation input from a user, and an alarm lamp.

The CPU 401, the ROM 402, the RAM 403, the NVRAM 404, the external device connection I/F 408, the network I/F 409, the coating unit roller driver 411, the conveyance roller driver 412, the sub-scanning driver 413, the sensor I/F 414, the inkjet head driver 420, the control panel 430, and the DA board 440 (the D/A converter 441) are data-communicable with each other via a bus 410, which is, for example, an address bus or a data bus.

The hardware configuration of the image forming apparatus 100 is not limited to that illustrated in FIG. 7. The image forming apparatus 100 does not necessarily include all the components illustrated in FIG. 7 or may include some other components.

### Comparative Example

A comparative example is described below.

First, when the speed of the motor 206 is controlled based on the analog voltage value converted from the digital signal by the D/A converter 441 of the DA board 440, the conveyance speed may be deviated from the target speed, and the conveyance accuracy may be affected by an offset of the analog voltage value generated in the DA board 440.

Second, when the medium is conveyed, the conveyance speed may fluctuate due to the influence of torque fluctuation during the medium conveyance or wear of the conveyance roller. The speed fluctuation of the coating roller 201 during the medium conveyance may cause the unevenness of the coating amount.

In techniques according to the comparative example to solve the above-described situations, a motor is rotated at a certain command value, and an offset amount of the command value is calculated from a difference between the rotation speed and an ideal rotation speed to correct the command value; or an actual conveyance speed of a medium is calculated by, for example, a conveyance sensor, and a rotation speed of each driver is corrected so that the rotation speed becomes a target predetermined speed.

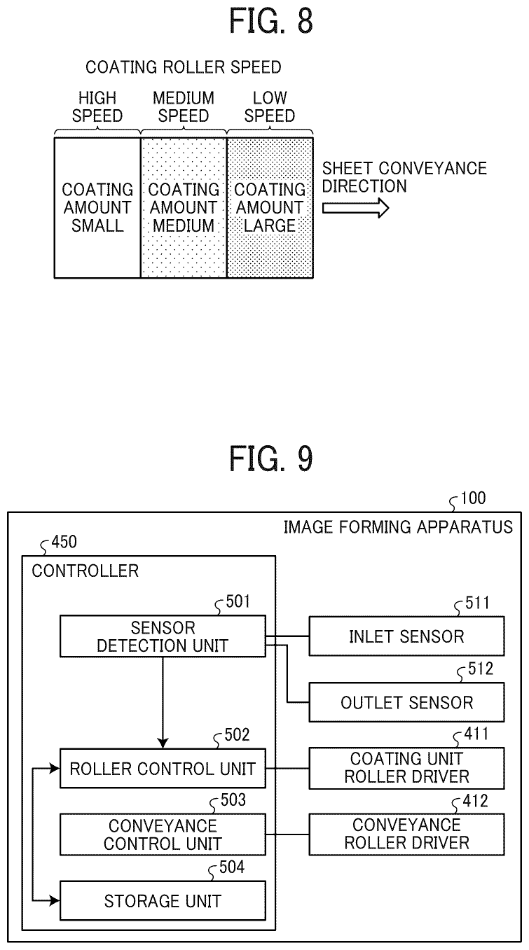

However, with the speed correction methods (techniques) according to the comparative example, when the speed is corrected while the coating roller applies the treatment agent for pre-coating to the surface of the medium, there are portions where the speed of the coating roller is low and portions where the speed of the coating roller is high in the medium, which may causes the unevenness of the coating amount of the treatment agent. FIG. 8 is a diagram illustrating a relationship between a speed of the coating roller 201 and a coating amount on the medium. As illustrated in FIG. 8, when the speed of the coating roller 201 is high, the coating amount of the treatment agent applied from the coating roller 201 to the medium is small. On the other hand, when the speed of the coating roller 201 is low, the coating amount of the treatment agent applied from the coating roller 201 to the medium is large. Accordingly, when the speed of the coating roller 201 fluctuates during the medium conveyance, the coating amount may become uneven.

Accordingly, in the present embodiment, a speed command correction amount (may be referred to simply as a correction amount) is reflected in the analog speed command for the motor 206 that drives the coating roller 201 when the medium is not passing through the coating roller 201, in other words, during a period from when the outlet sensor 512 has not detected the medium (i.e., from when the rear end of the preceding medium in the conveyance direction passes by the position of the outlet sensor 512) to when the inlet sensor 511 detects the next medium (i.e., to when the leading end of the following medium in the conveyance direction passes by the position of the inlet sensor 511), so that the speed correction is performed without the unevenness of the coating amount. This point will be described in detail below.

### Configuration and Operation of Functional Blocks of Image Forming Apparatus

FIG. 9 is a block diagram illustrating a functional configuration of an image forming apparatus. A description is given below of the configuration of the functional blocks of the image forming apparatus 100 with reference to FIG. 9. As illustrated in FIG. 9, the controller 450 of the image forming apparatus 100 includes a sensor detection unit 501, a roller control unit 502, a conveyance control unit 503, and a storage unit 504.

The sensor detection unit 501 is a functional unit that acquires, via the sensor I/F 414, a detection signal indicating that the medium is detected by the inlet sensor 511 and the outlet sensor 512. The roller control unit 502 is a functional unit that controls the rotation of the coating roller 201 via the coating unit roller driver 411. The roller control unit 502 outputs a speed command value for the motor 206 as a digital value of 12 bits.

The conveyance control unit 503 is a functional unit that independently controls the rotation of the inlet roller pairs 301 to 305, the outlet roller pairs 306 to 309, the purge roller pairs 310 to 313, the re-inlet roller pair 314, and the outlet roller pairs 315 and 316 of the pre-coating device 108 via the conveyance roller driver 412. The storage unit 504 is a functional unit that stores various kinds of data. The storage unit 504 is implemented by the ROM 402 or the NVRAM 404 illustrated in FIG. 7.

The sensor detection unit 501, the roller control unit 502, and the conveyance control unit 503 described above are implemented by executing a program by the CPU 401 illustrated in FIG. 7. The controller 450 as circuitry may include functions of the coating unit roller driver 411 and the conveyance roller driver 412, and the functions of the coating unit roller driver 411 and the conveyance roller driver 412 may also be implemented by executing a program by the CPU 401. At least a part of the sensor detection unit 501, the roller control unit 502, and the conveyance control unit 503 may be implemented by a hardware circuit such as a field-programmable gate array (FPGA) or an application-specific integrated circuit (ASIC).

Each functional unit of the image forming apparatus 100 illustrated in FIG. 9 is a conceptual representation of a function, and the functional configuration of the image forming apparatus 100 is not limited to that illustrated in FIG. 9. In other words, the functional units of the image forming apparatus 100 may not be software modules clearly configured as individual blocks as illustrated in FIG. 9, and the functions of the functional units may be implemented as a whole by the execution of a program on the image forming apparatus 100. For example, a plurality of functional units illustrated as independent functional units in the image forming apparatus 100 illustrated in FIG. 9 may be configured as one functional unit. On the other hand, functions provided for one functional unit of the image forming apparatus 100 illustrated in FIG. 9 may be divided into multiple functional units.

### Control of Motor for Driving Coating Roller in Pre-Coating Device

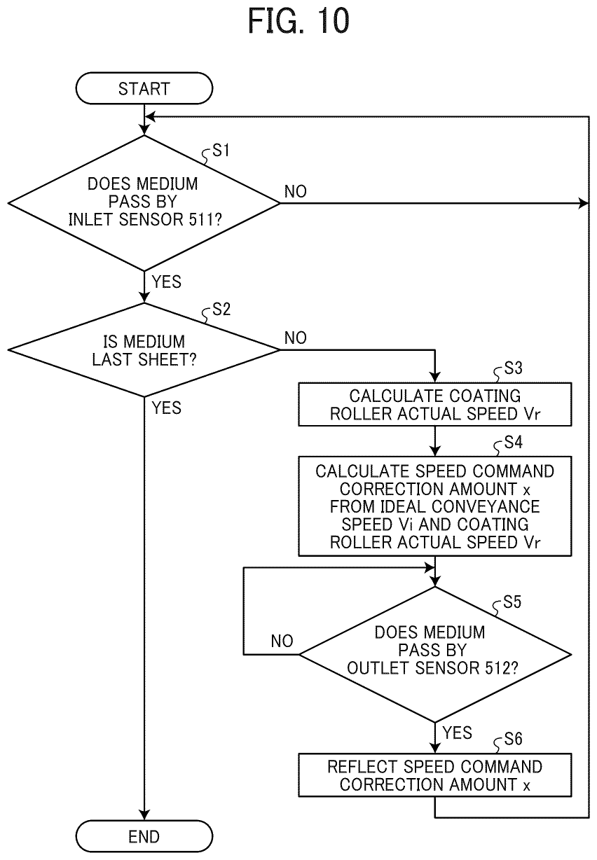

FIG. 10 is a flowchart of a drive control process of the coating roller 201. In the process illustrated in FIG. 10, a print interval of media (an interval between the preceding medium and the following medium) is longer than a distance from the inlet sensor 511 to the outlet sensor 512. The controller 450 of the image forming apparatus 100 determines that a period from when a medium passes by the outlet sensor 512 to when the next medium is detected by the inlet sensor 511 is a sheet interval. In other words, the controller 450 sets the print interval of the media to be longer than the distance from the inlet sensor 511 to the outlet sensor 512.

In step S1, the sensor detection unit 501 determines whether the inlet sensor 511 has detected whether a medium has passed by the inlet sensor 511. When the sensor detection unit 501 determines that the inlet sensor 511 has detected that the medium has passed by the inlet sensor 511 (Yes in step S1), in step S2, the roller control unit 502 determines whether the medium is the last sheet. For example, when a predetermined number of media have passed by the inlet sensor 511, the roller control unit 502 determines that the medium is the last sheet.

When the roller control unit 502 determines that the medium is the last sheet (Yes in step S2), the process ends. On the other hand, when the roller control unit 502 determines that the medium is not the last sheet (No in step S2), in step S3, the roller control unit 502 calculates a coating roller actual speed Vr, which is the rotation speed of the coating roller 201, using the encoder 207 attached to the motor shaft 206b of the motor 206, or the encoder 208c built into the motor 208 (i.e., based on an output from the encoder). The roller control unit 502 may calculate the coating roller actual speed Vr based on the conveyance speed of the medium calculated from the detection timing of the inlet sensor 511 and the outlet sensor 512 obtained from the sensor detection unit 501.

In step S4, the roller control unit 502 calculates a speed command correction amount x of the motor 206 from a difference between an ideal conveyance speed Vi of the medium and the coating roller actual speed Vr. In step S5, the sensor detection unit 501 determines whether the outlet sensor 512 has detected that the medium has passed by the outlet sensor 512. When the sensor detection unit 501 determines that the outlet sensor 512 has detected that the medium has passed by the outlet sensor 512 (Yes in step S5), in step S6, the roller control unit 502 reflects the speed command correction amount x of the motor 206 calculated in step S4 in the analog speed command for the motor 206 that drives the coating roller 201 to bring the coating roller actual speed Vr close to the ideal conveyance speed Vi of the medium.

As described above, the speed command correction amount x is reflected in the analog speed command for the motor 206 that drives the coating roller 201 when the medium is not passing through the coating roller 201, in other words, during a period from when the outlet sensor 512 has not detected the medium (i.e., from when the rear end of the preceding medium in the conveyance direction passes by the position of the outlet sensor 512) to when the inlet sensor 511 detects the next medium (i.e., to when the leading end of the following medium in the conveyance direction passes by the position of the inlet sensor 511).

With this speed correction method, the coating roller actual speed Vr can be kept constant when the medium is passing by the coating roller 201, and the unevenness of the coating amount in the medium can be reduced.

As described above, the speed command correction amount is calculated to correct the speed command value for the driver, the speed command correction amount is reflected in the speed command value while the conveyor is not conveying the recording medium (i.e., when the medium is not passing through the coating roller 201). Accordingly, portions where the speed of the conveyor is low and where the speed of the conveyor is high are not generated in the recording medium. As a result, the coating unevenness of the liquid applied to the recording medium, for example, the coating unevenness of the treatment agent for pre-coating can be reduced.

### Second Embodiment

A description is given below of a second embodiment of the present disclosure. The second embodiment is different from the first embodiment in that the speed correction is performed on the first medium. In the following description of the second embodiment, descriptions of elements identical or similar to those in the first embodiment are omitted, and differences from the first embodiment are described.

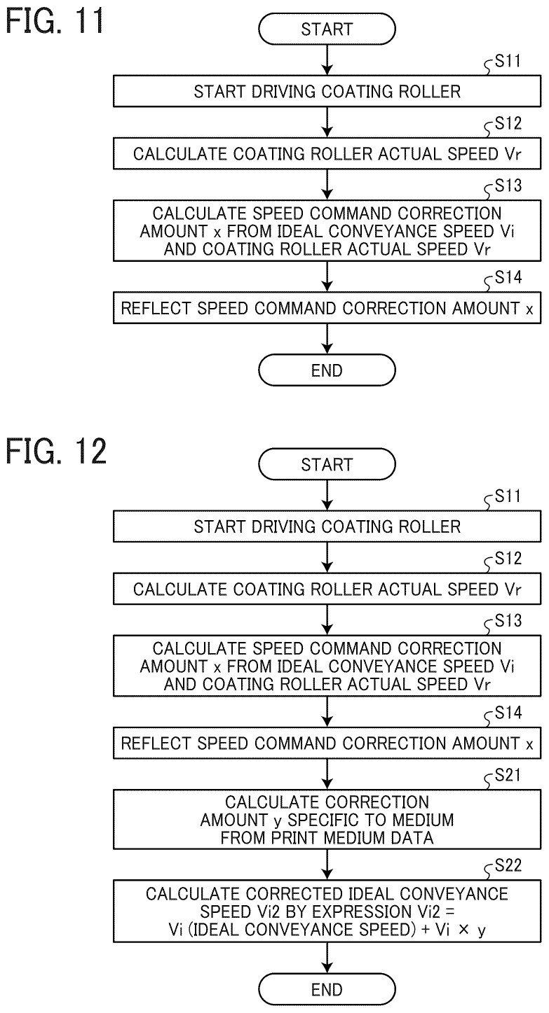

FIG. 11 is a flowchart of a drive control process of the coating roller 201 according to the second embodiment. As illustrated in FIG. 11, in step S11, the roller control unit 502 starts the rotation drive of the coating roller 201 before the start of printing (coating), or before the medium reaches the coating roller 201 after the start of printing (coating). In step S12, the roller control unit 502 calculates the coating roller actual speed Vr, which is the rotation speed of the coating roller 201, for example, using the encoder 207 attached to the motor shaft 206b of the motor 206, or the encoder 208c built into the motor 208. In step S13, the roller control unit 502 calculates the speed command correction amount x of the motor 206 from a difference between the ideal conveyance speed Vi of the medium and the coating roller actual speed Vr.

In step S14, the roller control unit 502 reflects the speed command correction amount x of the motor 206 calculated in step S13 in the analog speed command for the motor 206 that drives the coating roller 201 to bring the coating roller actual speed Vr close to the ideal conveyance speed Vi of the medium. For example, the roller control unit 502 corrects the coating roller actual speed Vr so that the actual rotation speed of the coating roller 201 corresponding to the ideal conveyance speed Vi becomes 3000 revolutions per minute (rpm). Due to such control, the speed fluctuation of the coating roller 201 due to the offset voltage inherent in the DA board 440 or the environment of the pre-coating device 108 can be corrected before the medium reaches the coating roller 201.

As described above, for example, after a predetermined time has elapsed from when the coating roller 201 is driven until the rotation speed is stabilized, and before the inlet sensor 511 detects the first medium (the leading end of the medium in the conveyance direction passes by the position of the inlet sensor 511), the speed command correction amount for correcting the speed command value for the driver can be calculated, and the speed command correction amount can be reflected in the speed command value.

### Third Embodiment

A description is given below of a third embodiment of the present disclosure. The third embodiment is different from the second embodiment in that data of the optimum rotation speed of the coating roller 201 for each type of medium is stored in advance. In the following description of the third embodiment, descriptions of elements identical or similar to those in the first embodiment or the second embodiment are omitted, and differences from the first embodiment and the second embodiment are described.

FIG. 12 is a flowchart of a drive control process of the coating roller 201 according to the third embodiment. In the present embodiment, in addition to the flow of the process described in the second embodiment, the data of the optimum rotation speed of the coating roller 201 (correction amount) for each medium is stored in advance in the storage unit 504 of the controller 450 to correct the speed reduction for each medium more precisely.

The storage unit 504 of the image forming apparatus 100 stores the type of medium and a correction amount y (i.e., another correction amount) in association with each other.

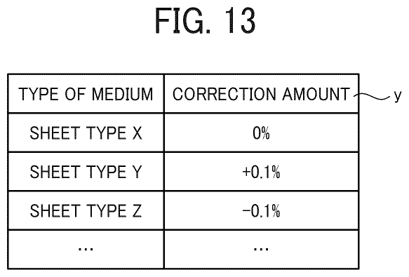

FIG. 13 is a lookup table of the correction amount y according to the type of medium. The lookup table illustrated in FIG. 13 associates the type of medium with the correction amount y. In the present embodiment, the lookup table as illustrated in FIG. 13 is stored in advance in the storage unit 504.

As illustrated in FIG. 12, in step S11, the roller control unit 502 starts the rotation drive of the coating roller 201 before the start of printing, or before the medium reaches the coating roller 201 after the start of printing. In step S12, the roller control unit 502 calculates the coating roller actual speed Vr, which is the rotation speed of the coating roller 201, for example, using the encoder 207 attached to the motor shaft 206b of the motor 206, or the encoder 208c built into the motor 208.

In step S13, the roller control unit 502 calculates the speed command correction amount x of the motor 206 from a difference between the ideal conveyance speed Vi of the medium and the coating roller actual speed Vr. In step S14, the roller control unit 502 reflects the speed command correction amount x of the motor 206 calculated in step S13 in the analog speed command for the motor 206 that drives the coating roller 201 to bring the coating roller actual speed Vr close to the ideal conveyance speed Vi of the medium.

In step S21, the roller control unit 502 determines the type of the medium from data of a print job, and calculates the correction amount y specific to the type of the medium based on the lookup table, as illustrated in FIG. 13, stored in advance in the storage unit 504. For example, when the ideal conveyance speed Vi of the medium corresponds to the actual rotation speed of the coating roller 201 of 3000 rpm, typically, the torque of the coating roller 201 is large for thick paper and small for thin paper, and thus the optimum speed command correction amount x of the motor 206 is ±0% for standard paper, +0.1% for thick paper, and −0.1% for thin paper.

Accordingly, in step S14, the roller control unit 502 performs correction so as to obtain the actual rotation speed of 3000 rpm. Then, in step S21, the roller control unit 502 determines the type of medium (data of a print medium) to be used from the data of the print job, and calculates the correction amount y specific to the type of medium from the data of the print medium. The roller control unit 502 can obtain the data of the print job from an external device connected via the external device connection I/F 408 or the network I/F 409.

In step S22, the roller control unit 502 sets a value obtained by reflecting the correction amount y calculated in step S21 in the ideal conveyance speed Vi of the medium as a corrected ideal conveyance speed Vi2. For example, if the correction amount y is 0.1% when the thick paper is used in the next job, the roller control unit 502 outputs an analog voltage value for the actual rotation speed of 3003 rpm (=3000 rpm+3000 rpm×0.1%) corresponding to the corrected ideal conveyance speed Vi2.

Due to such control, the coating roller 201 can be rotated at the optimum conveyance speed for each type of medium. This process is completed before the start of printing, or before the medium reaches the inlet sensor 511 after the start of printing, as in the second embodiment.

As described above, for example, after a predetermined time has elapsed from when the coating roller 201 is driven until the rotation speed is stabilized, and before the inlet sensor 511 detects the first medium (the leading end of the medium in the conveyance direction passes by the position of the inlet sensor 511), the speed command correction amount for correcting the speed command value for the driver can be calculated, and the speed command correction amount can be reflected in the speed command value. Further, the coating roller 201 can convey a medium at the optimum conveyance speed for each type of medium.

In the flowchart illustrated in FIG. 12, the correction for each type of medium is performed after the process of step S14 illustrated in FIG. 11, but the process is not limited thereto, and the actual speed correction of steps S11 to S14 may be performed after the correction amount for each type of medium is reflected.

When at least a portion of the functional units of the image forming apparatus 100 is implemented by executing a program, the program is preinstalled in, for example, a ROM (e.g., the ROM 402). Alternatively, the program executed by the image forming apparatus 100 may be stored, in an installable or executable file format, in a computer readable storage medium, such as a compact disc-read-only memory (CD-ROM), a flexible disk (FD), a compact disc-recordable (CD-R), and a digital versatile disc (DVD). Alternatively, the program executed by the image forming apparatus 100 may be stored in a computer connected to a network such as the Internet and downloaded via the network. The program executed by the image forming apparatus 100 may be provided or distributed via a network such as the Internet. The program executed by the image forming apparatus 100 has a module structure including at least one of the above-described functional units. Regarding the actual hardware related to the program, the CPU 401 reads and executes the program from the above-described storage device (e.g., the ROM 402 or the NVRAM 404) to load the program onto the main memory (e.g., the RAM 403) to implement the above-described functional units.

Aspects of the present disclosure are, for example, as follows.
Aspect 1

A coating device includes a conveyor, a driver, a controller, a D/A converter, and a drive circuit. The conveyor conveys a recording medium in a predetermined conveyance direction while applying a liquid to the recording medium by a rotation operation. The driver rotationally drives the conveyor. The controller outputs a speed command value, which is a digital signal, for the driver. The D/A converter converts the speed command value output from the controller into an analog voltage value. The drive circuit controls a rotation speed of the conveyor driven by the driver with the analog voltage value converted by the D/A converter. The controller calculates a speed command correction amount for correcting the speed command value for the driver, and reflects the speed command correction amount in the speed command value while the conveyor does not convey the recording medium.

In other word, a coating device includes a conveyor, a driver, circuitry, and a digital-to-analog converter. The conveyor includes a coating roller to coat a medium with a liquid while conveying the medium in a conveyance direction. The driver rotates the coating roller at a rotation speed. The circuitry outputs a speed command value as a digital value. The digital-to-analog converter converts the speed command value as the digital value into an analog voltage value. Further, the circuitry calculates a correction amount to correct the speed command value, reflects the correction amount in the speed command value when the medium is not passing through the coating roller, and applies the speed command value, as the analog voltage value corrected by the correction amount, to the driver to rotate the coating roller at the rotation speed to convey the medium.
Aspect 2

The coating device according to Aspect 1, further includes an inlet sensor disposed on an upstream side of the conveyor in the conveyance direction, and an outlet sensor disposed on a downstream side of the conveyor in the conveyance direction. The controller reflects the speed command correction amount in the speed command value during a period from when the outlet sensor does not detect the recording medium to when the inlet sensor detects a next recording medium.

In other word, the coating device according to Aspect 1, further includes an inlet sensor disposed upstream of the coating roller in the conveyance direction to detect the medium entering the coating roller and an outlet sensor disposed downstream of the coating roller in the conveyance direction to detect the medium exiting the coating roller. The circuitry reflects the correction amount in the speed command value after the outlet sensor has not detected a rear end of the medium and before the inlet sensor detects a leading end of a next medium next to the medium.
Aspect 3

In the coating device according to Aspect 1 or 2, the controller calculates the speed command correction amount for the driver from a difference between an ideal conveyance speed of the recording medium and an actual speed of the conveyor.

In other word, the circuitry calculates the speed command correction amount to correct the speed command value to control the driver to rotate the conveyor at the rotation speed based on a difference between an ideal conveyance speed of the recording medium and an actual speed of the conveyor.
Aspect 4

In the coating device according to any one of Aspects 1 to 3, the controller calculates the speed command correction amount for correcting the speed command value for the driver and reflects the speed command correction amount in the speed command value before coating, or before the recording medium reaches the conveyor after the start of coating.

In other word, wherein the circuitry calculates the correction amount and reflects the correction amount in the speed command value before the medium reaches the coating roller.
Aspect 5

In the coating device according to Aspect 4, the controller stores a table in which a correction amount is associated with each type of the recording medium, and reflects the correction amount corresponding to the type of the recording medium in the speed command value in addition to the speed command correction amount.

In other word, the circuitry stores a table in which another correction amount is associated with each type of the medium and reflects the correction amount and said another correction amount corresponding to the type of the medium in the speed command value.
Aspect 6

In the coating device according to any one of Aspects 1 to 5, the driver is an AC servo motor.

In other word, the driver is an alternating current servo motor.
Aspect 7

A liquid discharge apparatus includes the coating device according to any one of Aspects 1 to 6 and a discharge head to discharge a liquid onto a recording medium coated with the liquid by the coating device.

In other word, a liquid discharge apparatus includes the coating device according to any one of Aspects 1 to 6 and a discharge head to discharge another liquid to the medium coated with the liquid by the coating device.
Aspect 8

In the coating device according to Aspect 1, before the medium reaches the coating roller, the circuitry controls the driver to rotate the coating roller at the rotation speed, calculates an actual speed of the coating roller, calculates a difference between an ideal conveyance speed of the medium and the actual speed of the coating roller, and calculates the correction amount based on the difference calculated.
Aspect 9

In the coating device according to Aspect 8, the driver includes a motor and an encoder attached to the motor. The circuitry calculates the actual speed of the coating roller based on an output from the encoder.

As described above, according to one aspect of the present disclosure, the speed of the conveyor is corrected to reduce the coating unevenness of the liquid applied to the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A coating device comprising:
a conveyor including a coating roller to coat a medium with a liquid while conveying the medium in a conveyance direction;
a driver to rotate the coating roller at a rotation speed;
circuitry configured to output a speed command value as a digital value; and
a digital-to-analog converter to convert the speed command value as the digital value into an analog voltage value,
wherein the circuitry is further configured to:
calculate a correction amount to correct the speed command value;
reflect the correction amount in the speed command value when the medium is not passing through the coating roller; and
apply the speed command value, as the analog voltage value corrected by the correction amount, to the driver to rotate the coating roller at the rotation speed to convey the medium.

2. The coating device according to claim 1, further comprising:
an inlet sensor disposed upstream of the coating roller in the conveyance direction to detect the medium entering the coating roller; and
an outlet sensor disposed downstream of the coating roller in the conveyance direction to detect the medium exiting the coating roller,
wherein the circuitry is further configured to reflect the correction amount in the speed command value:
after the outlet sensor has not detected a rear end of the medium; and
before the inlet sensor detects a leading end of a next medium next to the medium.

3. The coating device according to claim 1,
wherein the circuitry is further configured to:
calculate a difference between an ideal conveyance speed of the medium and an actual speed of the conveyor; and
calculate the correction amount based on the difference calculated.

4. The coating device according to claim 1,
wherein the circuitry is further configured to:
calculate the correction amount; and
reflect the correction amount in the speed command value,
before the medium reaches the coating roller.

5. The coating device according to claim 4,
wherein the circuitry is further configured to:
store a table in which another correction amount is associated with each type of the medium; and
reflect:
the correction amount; and
said another correction amount corresponding to the type of the medium, in the speed command value.

6. The coating device according to claim 1,
wherein the driver is an alternating current servo motor.

7. A liquid discharge apparatus comprising:
the coating device according to claim 1; and
a discharge head to discharge another liquid to the medium coated with the liquid by the coating device.

8. The coating device according to claim 1,
wherein the circuitry is further configured to, before the medium reaches the coating roller:
control the driver to rotate the coating roller at the rotation speed;
calculate an actual speed of the coating roller;
calculate a difference between an ideal conveyance speed of the medium and the actual speed of the coating roller; and
calculate the correction amount based on the difference calculated.

9. The coating device according to claim 8,
wherein the driver includes:
a motor; and
an encoder attached to the motor, and
the circuitry calculates the actual speed of the coating roller based on an output from the encoder.
